(19) United States
(12) Patent Application Publication
(10) Pub. No.: US 2014/0325041 A1
(43) Pub. Date: Oct. 30, 2014

(54) METHOD, APPARATUS, SERVER AND SYSTEM FOR ADAPTING A CLIENT TO A HARDWARE ENVIRONMENT

(71) Applicant: Tencent Technology (Shenzhen) Co., Ltd., Shenzhen (CN)

(72) Inventors: Zhenyu XU, Shenzhen (CN); Zhutang Huang, Shenzhen (CN)

(73) Assignee: Tencent Technology (Shenzhen) Co., Ltd., Shenzhen (CN)

(21) Appl. No.: 14/196,271

(22) Filed: Mar. 4, 2014

Related U.S. Application Data
(63) Continuation of application No. PCT/CN2013/088955, filed on Dec. 10, 2013.

(30) Foreign Application Priority Data
Apr. 27, 2013 (CN) 2013101527652

(51) Int. Cl. H04L 12/24

(52) U.S. Cl. CPC H04L 41/0816
USPC 709/221

(57) ABSTRACT

A method, apparatus, server and system for adapting a client to a hardware environment is presented. A server obtains hardware environment information of a client. The hardware environment information includes one or both of hardware and software configuration information of the device terminal which support operations of the client, wherein the client includes an application having codes executable by the device terminal to perform at least one hardware function in the device terminal. The server sends matched configuration parameters according to the hardware environment information to the client. The client combines codes of the configuration parameters with codes of default dynamically configurable information to generate a correction result, which correction result is utilized by the client to perform the at least one hardware function in the device terminal.

### CROSS-REFERENCE TO RELATED APPLICATIONS

This application is a continuation of PCT Application No. PCT/CN2013/088955, filed on Dec. 10, 2013, which claims priority to Chinese Patent Application No. 2013101527652, filed on Apr. 27, 2013, which is incorporated by reference in their entireties.

### FIELD OF THE TECHNOLOGY

The present disclosure pertains to the field of software interacting with electronics hardware, and more particularly, a method, apparatus, server and system for adapting a client to a hardware environment.

### BACKGROUND

Certain consumer electronics products, such as computing devices, desk top computers, laptop computers, tablet computing devices, and especially mobile communication device terminals such as smart phones, may have a relatively short market life cycle due to frequent releases of newer models. Electronic hardware components as well as corresponding software (e.g., operating system (OS) and client applications software) which perform hardware functions interfaces, both evolve rapidly in these newer releases to the market.

A client—also known as application software in general, is specifically written according to the specifications of the manufacturers which supply the hardware component. The client performs processes to interface the functions of the hardware components under the control of the OS. For example, image processing functions and audio processing functions on a device terminal may each utilize a application software interface (API) having blocks of codes for execution.

Therefore, if a device terminal manufacturer releases a new model which uses image processing or audio processing components from a different supplier, or if the image processing or audio processing components from the same supplier has made substantial hardware upgrades, the corresponding application software which control the image processing or audio processing may need to be re-written and to be installed or downloaded into the new model. Otherwise, glitches may occur when an outdated client carries out the image processing or audio processing hardware functions on a new model.

Likewise, certain software such as an operating system (such as the Android® OS) may go through periodic upgrades to enhance performance. Such upgrades may be automatically downloaded into an existing device terminal as part of routine maintenance upgrades. Client application software written for an older version of the OS may no longer be properly supported by the newer version of the OS. In this regard, the user may need to download an upgraded driver or upgraded client application in order to avoid functional glitches which may cause unpleasant user experience.

Therefore, from the perspective of the hardware or software vendor's side, the effort of re-writing application software codes for upgrades is not trivial. From the user's perspective, the downloading of an entire upgraded client application software is time consuming and cumbersome, let alone consuming substantive memory resources in the device terminal, where older copies of the client application software may remain occupying memory space of the device terminal.

### SUMMARY

The various embodiments disclose a method, apparatus, server and system for adapting a client to a wide range of hardware environment and configuration changes in the device terminal. Instead of having to download an upgraded client (i.e., upgraded client application) to adapt to the hardware environment, hardware configuration parameters matching to the hardware environment of the client is downloaded. Codes from the configuration parameters are combined with codes from prior received default dynamic configuration information for the client. The combined codes execution by the client may produce correction results which may enable the client to continue to operate to perform the intended hardware functions and to adapt to the hardware environment without a need of an upgrade to the client itself. Accordingly, the hardware vendors may be benefited by not having to rewrite another client application, and user may be benefited by the device terminal downloading a much smaller block of codes (if necessary) which consume minimal memory resources on the device terminal. The adapting process is quick and reliable, thus improving user's experience.

An aspect of the disclosure discloses a method for a client to adapt to a hardware environment, which includes: obtaining by a server, hardware environment information of a client, wherein the hardware environment information includes one or both of hardware and software configuration information of a device terminal which support operations of the client, wherein the client includes an application having first codes performing at least one hardware function in the device terminal; sending by the server, configuration parameters to the client terminal, wherein the configuration parameters are matched to the hardware environment information; and adapting the client to the hardware environment, by combining second codes of the configuration parameters with third codes of default dynamic configuration information for the client, wherein a correction result is generated from executing the combined second codes and the third codes, wherein the correction result is being utilized when executing the first codes of the client to perform the at least one hardware function in the client.

Another aspect of the disclosure discloses a method for a client to adapt to a hardware environment, the method includes: sending by a client terminal, hardware environment information of the client terminal to a server, wherein the hardware environment information includes one or both of hardware and software configuration information of a device terminal which support operations of the client, wherein the client includes an application having first codes performing at least one hardware function in the device terminal; obtaining by the client, configuration parameters from the server, wherein the configuration parameters are matched to the hardware environment information; and adapting the client to the hardware environment, by combining second codes of the configuration parameters with third codes of default dynamic configuration information for the client, wherein a correction result is generated from executing the combined second codes and the third codes, wherein the correction result is being utilized when executing the first codes of the client to perform the at least one hardware function in the client terminal.

Another aspect of the disclosure discloses an apparatus for a client to adapt to a hardware environment. The apparatus includes at least a processor executing codes stored in at least a memory to perform functions of a plurality of modules and units, wherein the plurality of modules includes: a hardware information sending module, which sends hardware environment information of the apparatus to a server, wherein the hardware environment information includes one or both of hardware and software configuration information of the apparatus which support operations of the client, wherein the client includes an application having first codes performing at least one hardware function in the apparatus; a configuration parameters obtaining module which obtains from the server, configuration parameters matching to the hardware environment information; and a dynamic adaptation module, which adapts the client to the hardware environment, by combining second codes of the configuration parameters with third codes of default dynamic configuration information for the client, wherein a correction result is generated from executing the combined second codes and the third codes, wherein the correction result is being utilized when executing the first codes of the client to perform the at least one hardware function in the apparatus.

Another aspect of the disclosure discloses a server for configuring a client to adapt to a hardware configuration environment, which includes at least a processor executing codes stored in at least a memory to perform functions of a plurality of modules and units, wherein the plurality of modules include: a hardware information obtaining module, which obtains hardware environment information from the client, wherein the hardware environment information includes one or both of hardware and software configuration information of a device terminal which support operations of the client, wherein the client includes an application having first codes performing at least one hardware function in the device terminal; a configuration parameters sending module, which sends configuration parameters which are matched to the hardware environment information, wherein: the configuration parameters are utilized by the client terminal to adapt the client to the hardware environment, by combining second codes of the configuration parameters with third codes of default dynamic configuration information for the client, wherein a correction result is generated from executing the combined second codes and the third codes, wherein the correction result is being utilized when executing the first codes of the client to perform the at least one hardware function in the client terminal.

Another aspect of the disclosure discloses a system for adapting a client to a hardware configuration environment, wherein the system includes at least a device terminal and a server, wherein: the server obtains hardware environment information sent from the client terminal, wherein the hardware environment information includes one or both of hardware and software configuration information of a device terminal which support operations of the client, wherein the client includes an application having first codes performing at least one hardware function in the device terminal; the server sending matched configuration parameters according to the hardware environment information to the client; and the client adapts the client to the hardware environment, by combining second codes of the configuration parameters with third codes of default dynamic configuration information for the client, wherein a correction result is generated from executing the combined second codes and the third codes, wherein the correction result is being utilized when executing the first codes of the client to perform the at least one hardware function in the client terminal.

Still another aspect of the disclosure discloses a non-transitory computer-readable medium having stored thereon, a computer program having at least one code section being executable by a device terminal, for causing the device terminal to perform steps in adapting a client to a hardware environment, the steps includes: sending to a server, hardware environment information of the client, wherein the hardware environment information includes one or both of hardware and software configuration information of the device terminal which support operations of the client, wherein the client includes an application having first codes performing at least one hardware function in the device terminal; obtaining from the server, configuration parameters to be sent to the client, wherein the configuration parameters are matched to the hardware environment information; and adapting the client to the hardware environment, by combining second codes of the configuration parameters with third codes of default dynamic configuration information for the client, wherein a correction result is generated from executing the combined second codes and the third codes, wherein the correction result is being utilized when executing the first codes of the client to perform the at least one hardware function in the device terminal.

The various embodiments of the present disclosure achieve dynamic adaptation of the client to the hardware environment information by obtaining matched configuration parameters according to the hardware environment information from a server. The client may execute combined codes from the configuration parameters and from default dynamically configurable information for the client to generate a correction result, which correction result is being utilized by the codes in the client to perform hardware control functions in the client terminal. The benefits include without having to rewrite the client application, thus reducing development cost for the hardware and software vendors, and the user does not need to download an upgraded client application to replace the outdated client in the client terminal, thus improving user's experience.

### BRIEF DESCRIPTION OF THE DRAWINGS

The accompanying drawings are included to provide a further understanding of the claims and disclosure, are incorporated in, and constitute a part of this specification. The detailed description and illustrated embodiments described serve to explain the principles defined by the claims.

FIG. 1 is an exemplary process flow diagram illustrating a method for a client to adapt to a hardware environment, according to an embodiment of the present disclosure.

FIG. 2 is an exemplary process flow diagram illustrating a method for a client to adapt to a hardware environment, according to another embodiment of the present disclosure.

FIG. 3 is an exemplary process flow diagram illustrating a method for a client to adapt to a hardware environment, according to another embodiment of the present disclosure.

FIG. 4 is an exemplary process flow diagram illustrating a method for a client to adapt to a hardware environment, according to another embodiment of the present disclosure.

FIG. 5 is an exemplary structural schematic diagram illustrating an apparatus to carry out a method for a client to adapt to the hardware environment, according to an embodiment of the present disclosure.

FIG. 6 is an exemplary structural schematic diagram illustrating a Dynamic Adaptation module of the apparatus of FIG. 5, according to an embodiment of the present disclosure.

FIG. 7 is an exemplary structural schematic diagram illustrating a server to carry out a method for a client to adapt to the hardware environment in the apparatus of FIG. 5, according to an embodiment of the present disclosure.

FIG. 8 is an exemplary structural schematic diagram illustrating a Configuration Parameters Sending module of the server in FIG. 7, according to an embodiment of the present disclosure.

FIG. 9 is an exemplary structural schematic diagram illustrating a system for a client to adapt to the hardware environment as illustrated in FIGS. 5 and 7, according to an embodiment of the present disclosure.

### DETAILED DESCRIPTION OF THE EMBODIMENTS

The various embodiments of the present disclosure are further described in details in combination with attached drawings and embodiments below. It should be understood that the specific embodiments described here are used only to explain the present disclosure, and are not used to limit the present disclosure. In addition, for the sake of keeping description brief and concise, the newly added features, or features that are different from those previously described in each new embodiment will be described in details. Similar features will be referenced back to the prior descriptions.

For different embodiments of the present disclosure, the term “client” may be referred to as a running application processes in a device terminal. The client may include codes for calling or performing at least one hardware function in the device terminal according to hardware environment information.

For example, the client may be an application such as: instant messaging client, SNS (Social Networking Services) client etc. The client may call or perform hardware functions of the device terminal via interfaces provided by an operating system (OS), such as an Android® 4.1 OS, an iOS7®, Windows® OS, to name a few. The device terminals may include: a computing device such as a PC (Personal Computer), laptop computers, notebook computers, computing tablets, mobile phones, smart phones and any communication devices. The client may log into a server remotely through a network into a corresponding client account. The server may be a back-end server providing various services to the client, such as an instant messaging server, or a SNS server etc.

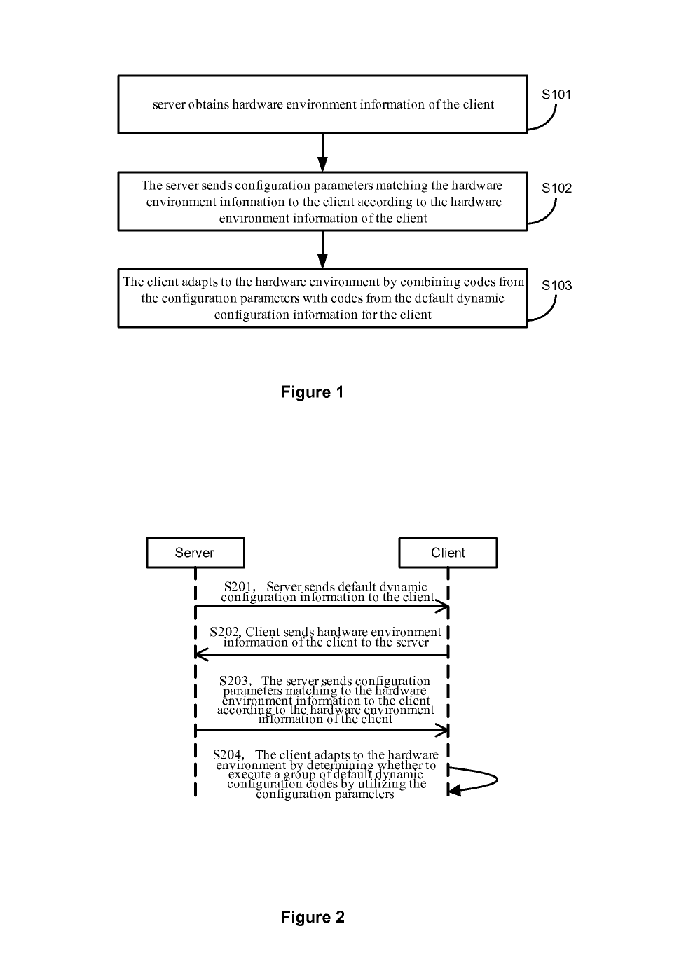

FIG. 1 is an exemplary process flow diagram illustrating a method for a client to adapt to a hardware environment, according to an embodiment of the present disclosure. Referring to FIG. 1, the exemplary process flow may include at least the following steps:

In step S101: a server may obtain hardware environment information of the client. Specifically, the server may obtain the hardware environment information of the device terminal from the client when first logging into the server by the client (or vice versa), or reconnecting with the client upon a loss of network connection after a previous logging in, or when the client sends a communication message to a communication account designated by the server.

The hardware environment information may include one or both of hardware and software configuration information of a device terminal which support operations of the client. For example, the hardware environment information of the client may be read from the device terminal's ROM (Read Only Memory, generally used for storing firmware information of the device terminal), which may include at least the following information:

Manuf (manufacturer): XX Company; (e.g., Apple, Samsung, HTC, Google, etc.)
Model (Model): X100; (e.g., iPhone 5S, S3, HTC 5, Nexus 4, etc.)
Ver (Version): 4.1; (e.g., Android® 4.1, iOS7®, etc.)

In step S102: the server may send configuration parameters matching the hardware environment information to the client according to the hardware environment information of the client. Specifically, the server may utilize the obtained hardware environment information from the client to search from a database, and to retrieve configuration parameters based on historical hardware adaptation problems which were encountered when running the clients under various hardware environments. In this regard, the configuration parameters are collected through multiple background maintenance teams, and are created through a mapping relationship between the configuration parameters and hardware environment information collected and stored in the database of the server. Accordingly, the server may look up from the database and obtain a set of configuration parameters matching the hardware environment information of the client through a mapped relationship between the various configuration parameters and the hardware environment information.

In addition, the configuration parameters may include codes which are to be executed along with other codes from another program to obtain desired results for the client's operation in the device terminal. Alternately, the codes in the configuration parameters may be a subset of codes embedded under another program. For example, the configuration parameters may be a portion of configuration parameters pertaining to default dynamic configuration information for the client, which are to be embedded within the client.

In an embodiment, the configuration parameters may be executable codes with codes from default dynamic configuration information, which may be utilized for calling camera functions or audio functions of the device terminal. For example, the configuration parameters may enable the following hardware functions in the hardware environment:

The size of previewing photos, such as to match the photo size to the same width and height as the display screen;

Setting a frame rate for previewing photos, such as 3 frames per second;
Setting formats of the photos as JPEG; (JointPhotographicExpertsGroup);
Setting the quality of photos to setting 85;
Setting sizes of the photos, such as to match the photo size to the same width and height as the display screen.

In step S103: the client may adapt to the hardware environment by combining codes from the configuration parameters sent by the server, with codes from the default dynamic configuration information for the client. Specifically, the default dynamic configuration information for the client may be obtained from the server in advance, and embedded in a local storage medium of the device terminal. The default dynamic configuration information may include one or more groups of dynamically configurable codes. Each group of dynamically configurable codes may target at respective different hardware environment information.

The client may determine that a group of dynamic configuration codes in the default dynamic configuration information may be utilized by the configuration parameters to adapt to the hardware environment information of the device terminal in which the client is located. The client may also correct portions of executable parameters or portions of the dynamically configurable codes in the default dynamic configuration information, using the configuration parameters.

Take for example, the dynamically configurable codes from the default dynamic configuration information may be used for calling camera functions in the device terminal. The configuration parameters may be utilized to replace a portion of the dynamically configurable codes from the default dynamic configuration information (i.e., the content in the parentheses of the dynamic execution codes above).

The client may also execute a selected portion and/or the corrected portion of the dynamic configuration codes from the default dynamic configuration information to execute the adaptation of the client to the hardware environment. The execution of the selected portion and/or the corrected dynamic configuration codes (as a result of utilizing the configuration parameters) may be carried out automatically by the client in the background.

FIG. 2 is an exemplary process flow diagram illustrating a method for a client to adapt to a hardware environment, according to another embodiment of the present disclosure. The exemplary steps may include:

Step S201: the server may send default dynamic configuration information to the client. More specifically, the server may send default dynamic configuration information to the client during a communication process with the client, such as when logging into the server by the client (or vice versa), reconnecting a loss connection from the network, or during any time after logging in by the client. The default dynamic configuration information for the client may include one or more groups of dynamically configurable codes, where each group of dynamic configuration codes may target at respective different hardware environment information.

In step S202: the client may send the hardware environment information of the client to the server. The client in the embodiment may read out the hardware environment information of the client from the ROM of the device terminal in which the client is located, and send them to the server when logging into the server by the client, or reconnecting to the server upon a connection loss after logging in by the client. The hardware environment information has been described in FIG. 1, and will not be repeated here.

S203: the server may send the configuration parameters matching to the hardware environment information to the client according to the hardware environment information of the client. Specifically, the server may utilize the obtained hardware environment information from the client to search from a database, and to retrieve configuration parameters based on historical hardware adaptation problems which were encountered when running the clients under various hardware environments. In this regard, the configuration parameters are collected through multiple background maintenance teams, and are created through a mapping relationship between the configuration parameters and hardware environment information collected and stored in the database of the server. Accordingly, the server may look up from the database and obtain a set of configuration parameters matching the hardware environment information of the client through a mapped relationship between the various configuration parameters and the hardware environment information and sent them to the client.

If the configuration parameters matching to the hardware environment information of the client cannot be found, the process may be ended. The configuration parameters in the embodiment may be execution parameters when executing the dynamic configuration codes of the default dynamic configuration information for the client. The configuration parameters may be used specifically for determining a group of dynamic configuration codes among the various groups of dynamic configuration codes of the default dynamic configuration information.

In step S204: the client may adapt to the hardware environment by determining whether to execute one of the groups of dynamic configuration codes from the default dynamic configuration information, utilizing the configuration parameters. More specifically, the client may determine that a group of dynamic configuration codes in the default dynamic configuration information for the client which were obtained in advance may match the hardware environment information of the client by utilizing the configuration parameters. Accordingly, the client may execute this group of the dynamic configuration codes from the default dynamic configuration information in order to adapt the client to the current hardware environment.

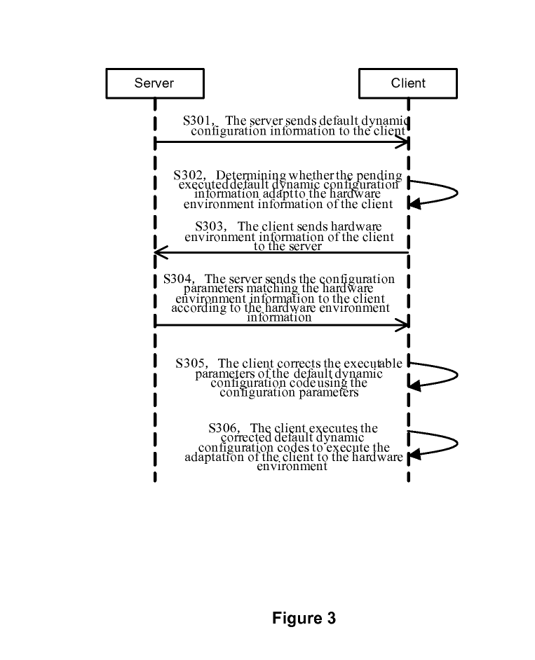

FIG. 3 is an exemplary process flow diagram illustrating a method for a client to adapt to a hardware environment, according to another embodiment of the present disclosure. The exemplary steps in the process flow may include:

In step S301: the server may send dynamic configuration information to the client. More specifically, the server may send default dynamic configuration information to the client during a communication process with the client, such as when logging into the server by client, reconnecting upon a loss network connection or any moment after logging into the server by the client. The default dynamic configuration information in the embodiment may include one or more groups of dynamic configuration codes, or may be modified utilizing the configuration parameters subsequently sent by the server. The dynamic configuration codes of the default dynamic configuration information are utilized for targeting specific hardware environment information.

In step S302: determining by the client, that the currently executed codes from the default dynamic configuration information does not adapt to the hardware environment information of the client. More specifically, the client may determine whether the currently executed codes from the default dynamic configuration information matches the hardware environment or not, when logging into the server by the client, or after reconnecting upon a loss connection, or any time after logging into the server by the client. The client may call at least one hardware function of the device terminal, e.g. testing a functional effect to decide whether test results meeting preset indicators via calling the hardware functions. If not, the default dynamic configuration information is determined not matched to the hardware environment information, then the process may proceed to step S303. It should be noted that step S302 in the current embodiment is only an optional step.

In step S303: the client may send the hardware environment information of the client to the server. The client in the current embodiment may read out the hardware environment information of the client from the ROM of the device terminal in which the client is located. The hardware environment information may be sent to the server when logging into the server by the client, or reconnecting upon a loss connection, or any time after logging into the server by the client, or after the client determining that the currently executed codes from the default dynamic configuration information does not match the hardware environment information of the client.

In step S304: the server sends the configuration parameters matching the hardware environment information to the client according to the hardware environment information of the client. Specifically, the server can get the configuration parameters by the solutions obtained based on the hardware adaptation problems emerged under the clients in various hardware environment collected through the background maintenance team, and create the mapped relationship between the configuration parameters and hardware environment information in the database of the server, so as to look up and obtain the configuration parameters matching the hardware environment information of the client in the mapped relationship between the various configuration parameters and the hardware environment information created in the database after obtaining the hardware environment information of the client, and sent it to the client, if the configuration parameters matching the hardware environment information of the client cannot be found, the process can be ended. The configuration parameters in the embodiment can be execution parameters when executing the dynamic configuration codes of the dynamic configuration information, it can be used specifically for modifying the dynamic configuration codes in the dynamic configuration information preset at the client to adapt the specific hardware environment information.

S305: the client corrects the execution parameters of the dynamic configuration code by the configuration parameters. Specifically, take the example mentioned above that calling dynamic execution codes of the camera functions of the device terminal as example, the execution parameters of the dynamic configuration codes which are corrected by the configuration parameters may be: replace the execution parameters of currently executed dynamic configuration information with the configuration parameters obtained from the server.

S306: the client executes the corrected dynamic configuration codes to execute the adaptation of the client to the hardware environment.

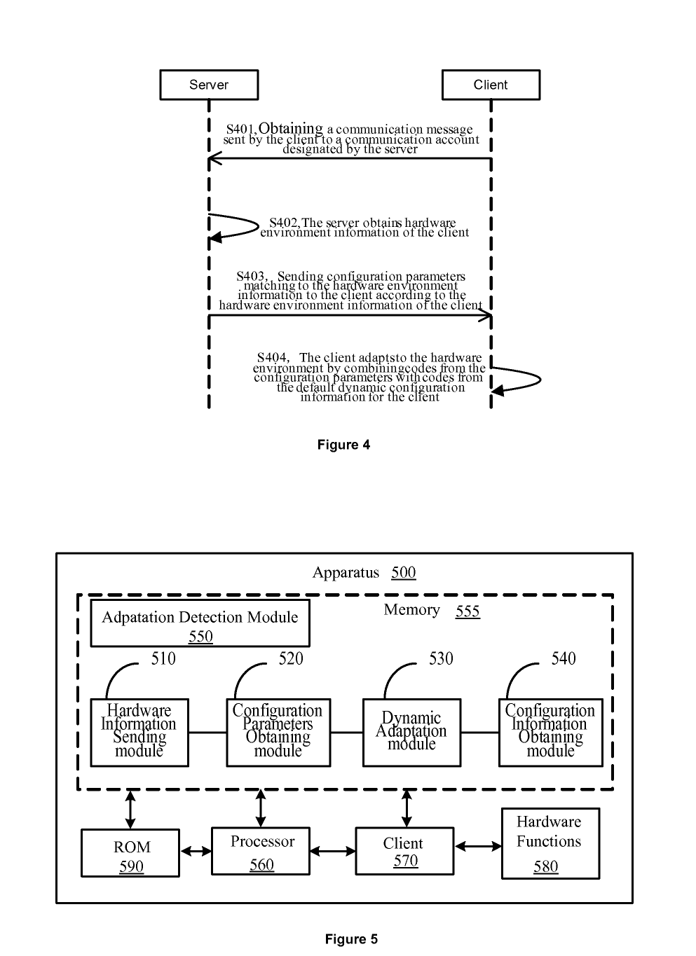

FIG. 4 is an exemplary process flow diagram illustrating a method for a client to adapt to a hardware environment, according to another embodiment of the present disclosure. The exemplary steps in the process flow may include:

In step S401: the server obtaining a communication message sent by the client to a communication account designated by the server. More specifically, the client may send the communication message to the server-specified communication account such as an account from a background maintenance team. The client may automatically read the hardware environment information of the device terminal in which the client is located, and attach the information in the communication message when sending the communication message to the server.

In step S402: the server may obtain the hardware environment information of the client. Specifically, the communication message sent to the specified communication account may pass through the server, or i.e. the communication message may be sent to a background of the server. Alternatively, the client may also carry with the communication message, problems or defects encountered when running the client under the current hardware environment in the communication message. In other words, the client may send along the troubles history encountered by the client, such that the server may find a solution to debug or trouble shoot the troubles of the client through sending back configuration parameters which match the hardware environment of the client in the next step S403.

In step S403: the server sending the configuration parameters matching the hardware environment information to the client according to the hardware environment information of the client. More specifically, the background maintenance team of the server may seek solutions to the troubles encountered by the client, by analyzing the hardware adaptation problems (i.e., through the communication message to the designated communication account) emerged under the clients in various currently collected hardware environment, to get the configuration parameters which target the hardware adaptation problems in various hardware environment information.

A mapped relationship is created between the configuration parameters and hardware environment information in the database of the server, so as to facilitate looking up and obtaining the configuration parameters which match the hardware environment information of the client. The mapped relationship between the various configuration parameters and the hardware environment information created in the database is obtained by the server, and sent to the client. If the configuration parameters matching the hardware environment information of the client cannot be found, the process may be ended.

In an optional embodiment, the background maintenance team of the server may design configuration parameters for the client to resolve the hardware adaptation problems, or to resolve defects problems encountered when running the clients in the current hardware environment. Adaptation problems or defects encountered when running the client in the current hardware environment may be carried in the communication message, and sent by the client to the communication account designated by the server.

In step S404: the client adapts to the hardware environment by combining the configuration parameters sent by the server with the default dynamic configuration information for the client. More specifically, the client may combine codes of the configuration parameters with codes of default dynamic configuration information for the client. A correction result may generated from executing the combined codes, wherein the correction result is being utilized when executing codes of the client to perform at least one hardware function in the device terminal.

For example, the client may determine that a group of dynamic configuration codes embedded in the default dynamic configuration information for the client should be utilized by the configuration parameters in order to match to the hardware environment information of the device terminal. Alternately, the client may utilize codes from the configuration parameters to correct executable parameters of the embedded dynamic configuration codes of the default dynamic configuration information for the client should be utilized by the configuration parameters in order.

Take the example mentioned above regarding calling for dynamic execution codes of the camera functions of the device terminal as example, the execution parameters of pending or currently executed default dynamic configuration information may be replaced with the configuration parameters obtained from the server. The client may execute the selected and/or corrected dynamic configuration codes in order to execute or perform the adaptation of the client to the hardware environment. However, such execution may be performed only after utilizing codes from the configuration parameters to determine for the selected and/or corrected dynamic configuration codes. Such process may be executed automatically in the background by the client.

In an optional embodiment, if the configuration parameters sent by the server is for targeting only the present client, the client may report the adaptation result back to the server after executing the adaptation of the client to the hardware environment by the default dynamic configuration information together with the configuration parameters. In this regard, the server may know whether the configuration parameters could successfully resolve the adaptation problems under the hardware environment, if yes, the configuration parameters may be pushed to other clients which possess the same hardware environment information.

FIG. 5 is an exemplary structural schematic diagram illustrating an apparatus (500) to carry out a method for a client (570) to adapt to the hardware environment, according to an embodiment of the present disclosure. The apparatus (500) may be a function module or an application independent from the client (570), or located within a PC (Personal Computer), tablets, mobile phones, smart phones, laptops and other device terminals. Alternately, the apparatus (500) may be by itself, an entire device terminal, such as a PC (Personal Computer), tablets, mobile phones, smart phones, or laptops.

The apparatus (500) for the client (570) to adapt to the hardware environment as shown in FIG. 5 may include at least a processor (560) executing codes stored in at least a memory (555) to perform functions of a plurality of modules and units, wherein the plurality of modules may include:

A hardware information sending module (510), which sends hardware environment information of the apparatus (500) to a server (700) (see FIG. 7), wherein the hardware environment information may include one or both of hardware and software configuration information of the apparatus (500) which support operations of the client (570), wherein the client (570) may include an application having first codes executable by the apparatus (500) to perform at least one hardware function (580) in the apparatus (500).

In addition, the hardware information sending module (510) may perform: uploading the hardware environment information to the server during logging into or reconnecting to the server, and sending communication message to a communication account designated by the server, wherein the communication message carries the hardware environment information of the apparatus (500).

The hardware information sending module (510) may read out the hardware environment information of the client (570) from the client's ROM (590), for example to include the following information:

Manuf (manufacturer): XX Company;

### Model (Model): X100;

### Ver (Version): 4.1;

A configuration parameters obtaining module (520) which obtains from the server (700) (see FIG. 7), configuration parameters matching to the hardware environment information. The configuration parameters may be configuration parameters of the dynamic configuration information embedded in the client (570), or execution parameters of the dynamic configuration code in the execution dynamic configuration information, such as the configuration parameters used for calling the camera functions of the device terminal.

For example, the configuration parameters may enable the following hardware functions in the hardware environment:

The size of previewing photos, such as to match the photo size to the same width and height as the display screen;

Setting a frame rate for previewing photos, such as 3 frames per second;
Setting formats of the photos as JPEG; (JointPhotographicExpertsGroup);
Setting the quality of photos to setting 85;
Setting sizes of the photos, such as to match the photo size to the same width and height as the display screen.

A dynamic adaptation module (530), which adapts the client (570) to the hardware environment, by combining second codes of the configuration parameters with third codes of default dynamic configuration information for the client (570), wherein a correction result may be generated from executing the combined second codes and the third codes, wherein the correction result is being utilized when executing the first codes of the client (570) to perform the at least one hardware function (580) in the apparatus (500).

The default dynamic configuration information for the client may be obtained from the server in advance, and may include one or more groups of dynamically configurable codes to be embedded in a local storage medium, such as in memory (550). Each group of dynamic configuration code may target to respective different hardware environment.

The dynamic adaptation module (530) may automatically execute the default dynamic configuration information for the client in the background based on the configuration parameters obtained by configuration parameters obtaining module (520) to execute the adaptation of the client to the hardware environment.

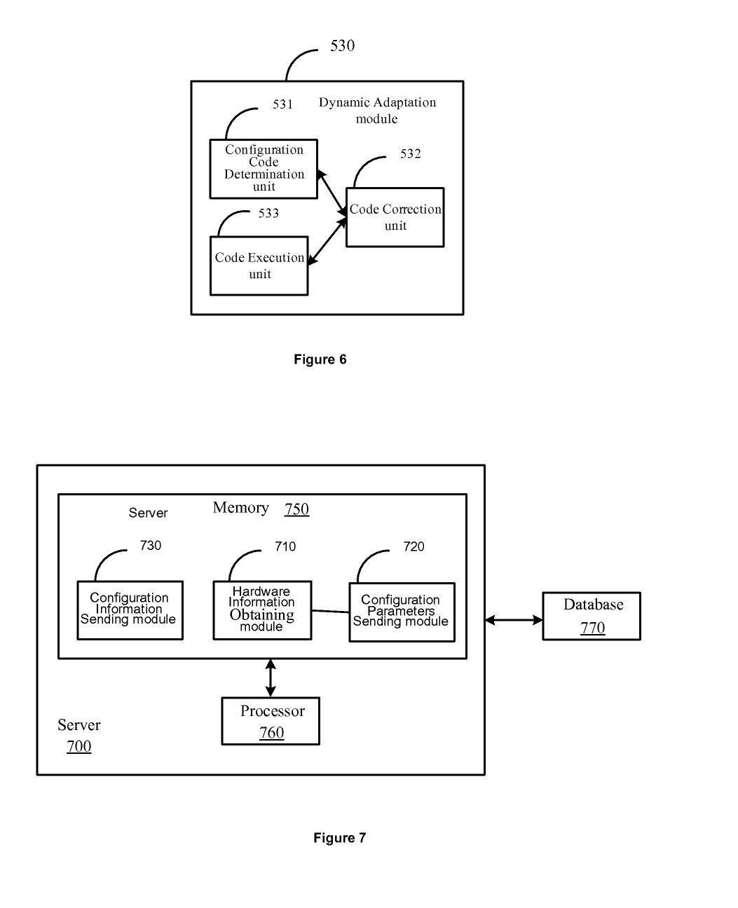

FIG. 6 is an exemplary structural schematic diagram illustrating a Dynamic Adaptation module of the apparatus of FIG. 5, according to an embodiment of the present disclosure. The dynamic adaptation module (530) further includes:

A configuration code determination unit (531), which determines according to the configuration parameters, which one group from the one or more groups of dynamically configurable codes in the default dynamic configuration information for the client (570) is to be combined with the second codes of the configuration parameters. The determination unit (531) may determine a group of dynamic configuration codes in the dynamic configuration information by the configuration parameters to match the hardware environment information of the apparatus in which the client is located.

A code correction unit (532) which corrects execution parameters of the dynamic configuration code by the configuration parameters. Take the example mentioned above regarding calling dynamic execution codes of the camera functions in the device terminal as example, code correction unit (532) may replace the execution parameters of pending or currently executed dynamic configuration information with the configuration parameters obtained from the server.

A code execution unit (533) which executes the one group from the one or more groups of dynamically configurable codes in the default dynamic configuration information for the client to perform the at least one hardware function (580) in adapting to the hardware environment. The code execution unit (533) executes corrected executable parameters in the dynamically configurable codes according to the configuration parameters to perform the at least one hardware function (580) in adapting to the hardware environment.

The code execution unit 533 may execute selected and/or corrected dynamic configuration codes to execute the adaptation of the client (570) to the hardware environment. This process may be executed automatically in the background. It should be noted that in the dynamic adaptation module (530) of the embodiment of the present disclosure, configuration code determination unit (531) and code correction unit (532) may all exist, or only one of the units can exist.

Furthermore, the apparatus (500) for the client (570) to adapt the hardware environment in the embodiment of the present disclosure also may include:

A configuration information obtaining module (540), for obtaining the dynamic configuration information sent by the server (700). More specifically, the server (700) may send dynamic configuration information to the client (570) during a communication process with the client (570), such as when logging into the server (700) by the client (570), reconnecting upon loss or any time during the operational process after the client (570) logging into the server (700). The dynamic configuration information in the embodiment may include one or more groups of dynamic configuration codes, each group of dynamic configuration codes may target to respective different hardware environment information.

Furthermore, the apparatus (500) for the client (570) to adapt to the hardware environment in the embodiment of the present disclosure also may include:

An adaptation detecting module (550), for detecting whether a currently or pending executed default dynamic configuration information for the client adapts to the hardware environment information of the client (570), if not, the hardware information sending module (510) may be triggered to send the hardware environment information of the client (570) to the server (700). More specifically, the adaptation detecting module (550) may detect whether the pending or currently executed default dynamic configuration information matches the hardware environment when logging into the server by the client, or reconnecting upon a loss connection after logging into the server by the client, or when calling the hardware functions (590) of the apparatus (700), e.g. the functional effect can be tested and decided whether it meets the preset indicators via calling the hardware functions (590), if not, the currently executed dynamic configuration information is determined not adapt the hardware environment information of the client (i.e., which are stored in the ROM (590)).

FIG. 7 is an exemplary structural schematic diagram illustrating a server (700) to carry out a method for a client (570) to adapt to the hardware environment in the apparatus (500) of FIG. 5, according to an embodiment of the present disclosure. The server (700) as shown may be a back-end server providing services to the client, such as instant messaging server, SNS server etc. The server (700) may include least a processor (760) executing codes stored in at least a memory (750) to perform functions of a plurality of modules and units, wherein the plurality of modules may include:

A hardware information obtaining module (710), which obtains hardware environment information (i.e., stored in the ROM (590)) from the client terminal or apparatus (500), wherein the hardware environment information includes one or both of hardware and software configuration information of the client terminal which support operations of the client (570), wherein the client (570) may include an application having first codes executable by the device terminal to perform at least one hardware function (580) in the device terminal;

The hardware information obtaining module (710) may obtain the hardware environment information from the client (570) after the client (570) logging into the server (700) (or vice versa), or reconnecting upon loss of connection after logging in by the client (570). The hardware information obtaining module (710) also may obtain a communication message sent by the client (570) to a communication account designated by the server (700), and the communication message may carries the hardware environment information of the client (570). In this regard, the hardware information obtaining module (710) obtains the hardware environment information of the client (570) which is carried in the communication message.

A configuration parameters sending module (720), which sends configuration parameters which are matched to the hardware environment information, wherein: the configuration parameters are utilized by the client (570) to adapt the hardware environment, by combining second codes of the configuration parameters with third codes of default dynamic configuration information for the client (570), wherein a correction result is generated from executing the combined second codes and the third codes, wherein the correction result is being utilized when executing the first codes of the client (570) to perform the at least one hardware function (580) in the device terminal (or the apparatus (500)).

A configuration information sending module (730), which sends the default dynamic configuration information to the client (570). More specifically, the configuration information sending module (730) may send the configuration parameters matching to the hardware environment information to the client (570) according to the hardware environment information of the client (570). The server (700) may utilize the obtained hardware environment information from the client to search from a database (770), and to retrieve configuration parameters based on historical hardware adaptation problems which were encountered when running the clients under various hardware environments. In this regard, the configuration parameters are collected through multiple background maintenance teams, and are created through a mapping relationship between the configuration parameters and hardware environment information collected and stored in the database (770) of the server (700). Accordingly, the server (700) may look up from the database (770) and obtain a set of configuration parameters matching the hardware environment information of the client (570) through a mapped relationship between the various configuration parameters and the hardware environment information and sent them to the client (570).

If the configuration parameters matching to the hardware environment information of the client (570) cannot be found, the process may be ended. The configuration parameters in the embodiment may be execution parameters when executing the dynamic configuration codes of the default dynamic configuration information for the client. The configuration parameters may be used specifically for determining a group of dynamic configuration codes among the various groups of dynamic configuration codes of the default dynamic configuration information.

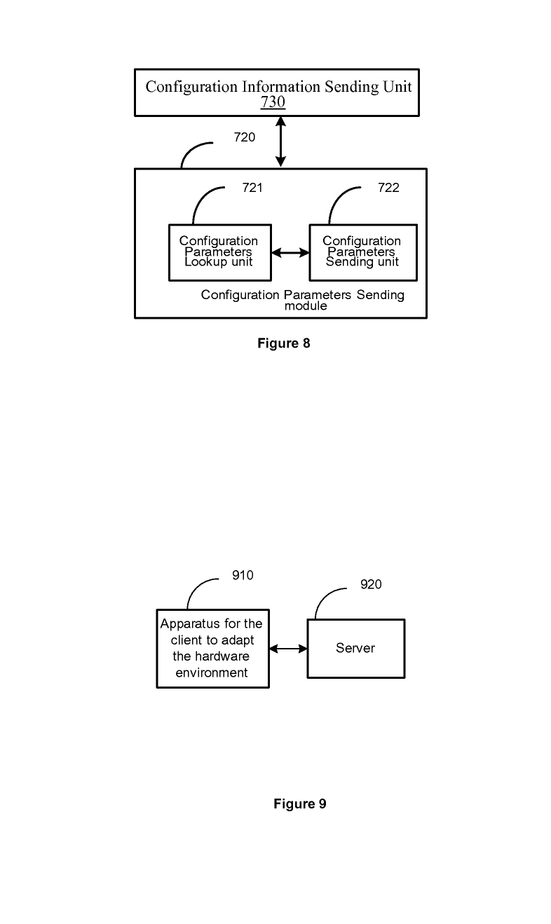

FIG. 8 is an exemplary structural schematic diagram illustrating a Configuration Parameters Sending module of the server in FIG. 7, according to an embodiment of the present disclosure. As shown, the configuration parameters sending module (720) may include:

A configuration parameters lookup unit (721), which looks up a corresponding relationship between default hardware environment information and the configuration parameters matched to the hardware environment information of the client in a database of the server.

A configuration parameters sending unit (722), which sends the matched configuration parameters to the client (570).

Furthermore, the server (700) in the embodiment may also include:

A configuration information sending module (730), for sending the dynamic configuration information to the client. More specifically, the configuration information sending module (730) may send dynamic configuration information to the client (570) during the communication process with the client, such as when logging into the client (570) or when the client logging into the server (700), reconnecting upon loss of connection or any time during the operational process after logging. Optionally, the dynamic configuration information in the embodiment may include one or more groups of dynamic configuration codes, each group of dynamic configuration codes target to respective different hardware environment information.

FIG. 9 is an exemplary structural schematic diagram illustrating a system for a client (570) to adapt to the hardware environment as illustrated in FIGS. 5 and 7, according to an embodiment of the present disclosure. The system may include at least an apparatus (910) (i.e., a device terminal) and a server (920), wherein: the server (920) obtains hardware environment information sent from the client (570) (see FIG. 5), wherein the hardware environment information includes one or both of hardware and software configuration information of the apparatus (910) which support operations of the client (570), wherein the client comprises an application having first codes executable by the apparatus (910) to perform at least one hardware function (580) in the apparatus (910).

The server (920) sending matched configuration parameters according to the hardware environment information to the client (570); and the client adapts to the hardware environment, by combining second codes of the configuration parameters with third codes of default dynamic configuration information for the client, wherein a correction result is generated from executing the combined second codes and the third codes, wherein the correction result is being utilized when executing the first codes of the client (570) to perform the at least one hardware function (580) in the apparatus (910).

An example of a method for a client to adapt to a hardware environment, may be illustrated with the following sequence of steps written in pseudo codes (with a brief explanation):

//Step 1: Send The Information of Current Device and OS, like {SAMSUNG, Galaxy S3, Android 4.1} To Server

### SendDeviceInfoToSVRO:

//Step 2: Get The Configuration List contains the Parameters/Codes that The App can execute dynamically
//Server will send Different Configurations To Different Devices

### ConfiList=GetConfFromSVR( );

### DoDifferentLogicByConf(ConfiList);

//The Configuration contains different parameters
//The Parameters in ConfigurationList like 90°, 180°, 270° can help to fix the upside-down Problem with Carema (Galaxy S3 maybe 90°, LG Nexus 4 maybe 180°)
//The Parameters in ConfigurationList like whether some device should record sound in amr or in mp3 (Different devices has different types of hardware to deal with sound recording)
//The Parameters in ConfigurationList like different device should record sound within different compression ratio
. . .
//Step 3: Furthermore Some Codes (Binary or Code can be ok) can download and execute dynamically

### GetExecuteCodeFromSVR( )

### InitiForNewExecuteCode( )

### Execute( )

. . .
. . .
. . .

As seen, the above illustrated method deals with different hardware and software configurations only. There is no requirement for an update to the client application to a new version. Accordingly, different devices may execute different logic received from the server as different configuration parameters, which are matched with respect to the hardware information supplied by the client.

It can be appreciated that the embodiments of the present disclosure achieve dynamic adaptation of the hardware environment for a client by sending the hardware environment information of the client to the server and obtaining configuration parameters matching the hardware environment from the server, to make the client adapts the hardware environment by combining the default dynamic configuration information for the client with the configuration parameters, so as to provide better user experiences via calling hardware functions of the device terminal by the client.

It should be understood by those with ordinary skill in the art that all or some of the steps of the foregoing embodiments may be implemented by hardware, or software program codes stored on a non-transitory computer-readable storage medium with computer-executable commands stored within. For example, the disclosure may be implemented as an algorithm as codes stored in a program module or a system with multi-program-modules. The computer-readable storage medium may be, for example, nonvolatile memory such as compact disc (CD), hard drive, ROM, RAM or flash memory. The computer-executable commands are used to enable a computer, server, a smart phone, a tablet or any similar computing device to accomplish the cross-platform video playing operations.

Disclosed above are only preferred embodiments of the present disclosure and these preferred embodiments are not intended to be limiting the scope of rights of the present disclosure, hence any equivalent changes made according to the claims of the present disclosure shall fall within the scope of the present disclosure.

The foregoing represents only some preferred embodiments of the present disclosure and their disclosure cannot be construed to limit the present disclosure in any way. Those of ordinary skill in the art will recognize that equivalent embodiments may be created via slight alterations and modifications using the technical content disclosed above without departing from the scope of the technical solution of the present disclosure, and such summary alterations, equivalent has changed and modifications of the foregoing embodiments are to be viewed as being within the scope of the technical solution of the present disclosure.

What is claimed is:

1. A method for a client to adapt to a hardware environment, comprising:
obtaining by a server, hardware environment information of a client, wherein the hardware environment information comprises one or both of hardware and software configuration information of a device terminal which support operations of the client, wherein the client comprises an application having first codes performing at least one hardware function in the device terminal according to the hardware environment information;
sending by the server, configuration parameters to the client, wherein the configuration parameters are matched to the hardware environment information; and
adapting the client to the hardware environment, by combining second codes of the configuration parameters with third codes of default dynamic configuration information for the client, wherein a correction result is generated from executing the combined second codes and the third codes, wherein the correction result is being utilized when executing the first codes of the client to perform the at least one hardware function in the device terminal.

2. The method according to claim 1, wherein prior to executing the client, the method comprising:
sending by the server, the default dynamic configuration information for the client to the device terminal.

3. The method according to claim 1, wherein the sending by the server, configuration parameters to the client, comprising:
looking up from a database by the server, a corresponding relationship between a default hardware environment information and the configuration parameters which matches to the hardware environment information of the client;
sending by the server, the configuration parameters to the client.

4. The method according to claim 1, wherein the default dynamic configuration information for the client comprises one or more groups of dynamically configurable codes; and the combining of the second codes of the configuration parameters with the third codes of the default dynamic configuration information for the client, comprising:
determining by the client according to the configuration parameters, which one group from the one or more groups of dynamically configurable codes in the default dynamic configuration information for the client to be combined with the first codes of the configuration parameters.

5. The method according to claim 1, wherein the third codes of the default dynamic configuration information for the client comprise dynamically configurable codes; and the combining of the second codes of the configuration parameters with the third codes of the default dynamic configuration information for the client, comprising:
the client correcting executable parameters in the dynamically configurable codes according to the configuration parameters.

6. The method according to claim 1, wherein the obtaining of the hardware environment information of the client by the server, comprising:
obtaining the hardware environment information of the client during the client logging into or reconnecting to the server.

7. The method according to claim 1, wherein the obtaining of the hardware environment information of the client by the server, comprising:
receiving from the client, a communication message sent to a communication account designated by the server, wherein the communication message carries the hardware environment information of the client.

8. The method according to claim 1, wherein prior to the server obtaining the hardware environment information of the client, the method further comprising:
during executing pending third codes, determining by the client whether the default dynamic configuration information for the client is adapting to the hardware environment information, if not, the client sending the hardware environment information to the server.

9. An apparatus for a client to adapt to a hardware environment, the apparatus comprises at least a processor executing codes stored in at least a memory to perform functions of a plurality of modules and units, wherein the plurality of modules comprise:
a hardware information sending module, which sends hardware environment information of the apparatus to a server, wherein the hardware environment information comprises one or both of hardware and software configuration information of the apparatus which support operations of the client, wherein the client comprises an application having first codes executable by the apparatus to perform at least one hardware function in the apparatus;
a configuration parameters obtaining module which obtains from the server, configuration parameters matching to the hardware environment information; and
a dynamic adaptation module, which adapts the client to the hardware environment, by combining second codes of the configuration parameters with third codes of default dynamic configuration information for the client, wherein a correction result is generated from executing the combined second codes and the third codes, wherein the correction result is being utilized when executing the first codes of the client to perform the at least one hardware function in the apparatus.

10. The apparatus according to claim 9, comprises:
a configuration information obtaining module, which obtains the default dynamic configuration information for the client from the server.

11. The apparatus according to claim 9, wherein the default dynamic configuration information for the client comprises one or more groups of dynamically configurable codes;
the dynamic adaptation module comprises:
a configuration code determination unit, which determines according to the configuration parameters, which one group from the one or more groups of dynamically configurable codes in the default dynamic configuration information for the client is to be combined with the second codes of the configuration parameters;
a code execution unit which executes the one group from the one or more groups of dynamically configurable codes in the default dynamic configuration information for the client to perform the at least one hardware function in adapting to the hardware environment.

12. The apparatus according to claim 9, wherein second codes of the default dynamic configuration information for the client comprises dynamically configurable codes;
the dynamic adaptation module comprises:
a code correction unit which corrects execution parameters of the dynamic configuration code by the configuration parameters;
a code execution unit which executes corrected executable parameters in the dynamically configurable codes according to the configuration parameters to perform the at least one hardware function in adapting to the hardware environment.

13. The apparatus according to claim 9, wherein the hardware information sending module performs:
uploading the hardware environment information to the server during logging into or reconnecting to the server.

14. The apparatus according to claim 9, wherein the hardware information sending module performs:
sending communication message to a communication account designated by the server, wherein the communication message carries the hardware environment information of the apparatus.

15. The apparatus according to claim 9, wherein prior to the server obtaining the hardware environment information, the apparatus further comprises:
an adaptation detecting module, which during executing pending third codes, the client determining whether the default dynamic configuration information for the client is adapting to the hardware environment information, if not, the client sending the hardware environment information to the server.

16. A server for configuring a client to adapt to a hardware configuration environment in a device terminal, comprises at least a processor executing codes stored in at least a memory to perform functions of a plurality of modules and units, wherein the plurality of modules comprise:
a hardware information obtaining module, which obtains hardware environment information from the client terminal, wherein the hardware environment information comprises one or both of hardware and software configuration information of the client terminal which support operations of the client, wherein the client comprises an application having first codes executable by the device terminal to perform at least one hardware function in the device terminal;
a configuration parameters sending module, which sends configuration parameters which are matched to the hardware environment information, wherein:
the configuration parameters are utilized by the client to adapt the hardware environment, by combining second codes of the configuration parameters with third codes of default dynamic configuration information for the client, wherein a correction result is generated from executing the combined second codes and the third codes, wherein the correction result is being utilized when executing the first codes of the client to perform the at least one hardware function in the device terminal.

17. The server according to claim 16, comprises:
a configuration information sending module, which sends the default dynamic configuration information to the client.

18. The server according to claim 16, wherein the configuration parameters sending module comprises:
a configuration parameters lookup unit, which looks up a corresponding relationship between default hardware environment information and the configuration parameters matched to the hardware environment information of the client in a database of the server;
a configuration parameters sending unit, which sends the matched configuration parameters to the client.

19. The server according to claim 16, wherein the hardware information obtaining module performs:
obtaining the hardware environment information for the client, during the client logging into or reconnecting to the server.

20. The server according to claim 16, wherein the hardware information obtaining module performs:
obtaining from the client, a communication message sent to a communication account designated by the server, wherein the communication message carries the hardware environment information of the client.
